(19) United States
(12) Patent Application Publication
(10) Pub. No.: US 2026/0168211 A1
(43) Pub. Date: Jun. 18, 2026

(54) HYBRID ARCHITECTURE FOR SMART POWER MANAGEMENT ON OFF-HIGHWAY MACHINES

(71) Applicant: Deere & Company, Moline, IL (US)

(72) Inventors: GUNASEKARAN N. NATARAJ, Pune (IN); SUJIT WAGHMODE, Pune (IN)

(21) Appl. No.: 18/983,515

(22) Filed: Dec. 17, 2024

(51) Int. Cl. E02F 9/22; E02F 9/20; F15B 11/17; F15B 15/18

(52) U.S. Cl. CPC E02F 9/2246; E02F 9/2066; E02F 9/2095; E02F 9/2203; E02F 9/2257; E02F 9/2267; E02F 9/2292; F15B 11/17; F15B 15/18; E02F 9/2296

(57) ABSTRACT

A system and a method control the energy required from an internal combustion engine (ICE) of an off-highway machine having terrain-engagement members to move the machine and having hydraulic pumps to provide hydraulic flow to a material manipulation implement. The ICE drives the terrain-engagement members and a first hydraulic pump. The ICE drives an electrical generator to provide electrical energy, which is stored in a battery. The stored electrical energy is selectively provided to an electric motor that drives a second hydraulic pump. When a total energy provided by the ICE exceeds a predetermined level, the hydraulic flow provided by the first hydraulic pump is decreased, and the hydraulic flow provided by the second hydraulic pump is increased. The system and method enable a less powerful ICE to drive the machine.

### FIELD OF THE DISCLOSURE

This disclosure relates to a system and method for managing the power provided to the traction motors and the power provided to the hydraulic system of off-highway machines and agricultural machines using hybrid architecture.

### BACKGROUND

Off-highway machines are used to move bulk materials at construction sites and the like. Off-highway machines are also used in agriculture to prepare fields, plant and maintain crops, harvest and transport crops, and the like. The machines generally have large wheels or tracks as terrain engagement members to enable the machines to move on uneven terrain. The machines serve as mobile support platforms for hydraulically powered implements attached to the machines. The attached implements manipulate materials. For example, certain implements engage soil or other materials and move the soil or other materials to other locations. The attached implements may push or pull the materials to different locations on the terrain using a blade such as a blade on a dozer or grader. The attached implements may remove the material from the terrain using a bucket or other similar implement and carry the material to a new location, either directly or by transferring the material to a transport vehicle such as a truck. Other types of implements include grinders that transform bulk material (e.g., trees, used concrete or pavement, or the like) into smaller sized material.

Many off-highway machines are powered by internal combustion engines (ICEs) such as diesel engines. An ICE may also be referred to herein as a prime mover. An ICE may power the wheels or tracks of the machine directly via gearboxes and the like; however, many machines drive the wheels or tracks using a hydrostatic pump that generates fluid flow to run hydrostatic motors that are connected to the wheels or tracks. The hydrostatic pump is driven by the ICE. The ICE also drives a hydraulic pump that provides hydraulic fluid flow to operate hydraulic cylinders and/or motors that operate the hydraulic powered implements attached to the machine. The ICE may drive the hydraulic pump directly or may drive the hydraulic pump indirectly via the hydro static pump.

An ICE for an off-highway machine must have sufficient power to drive the hydrostatic pump and thereby drive the hydrostatic motors to move the machine to different locations on the terrain and to drive the hydraulic pump (either directly or indirectly). The ICE also must have sufficient power to provide hydraulic flow to the implements attached to the machine. In many situations, the machine must be moved and the implements must be operated at the same time. Thus, the ICE must be capable of providing sufficient power for driving the wheels or tracks simultaneously with manipulating materials with the implements.

Although incorporating a larger ICE into an off-highway machine to provide sufficient power to move the machine while simultaneously manipulating materials may be a solution for some applications, a larger ICE requires additional packaging volume in comparison with a smaller ICE. The efficiency of a larger ICE may be lower than the efficiency of a smaller ICE. A larger ICE may also reach or exceed the horsepower limit where additional pollution control is required. For example, an ICE producing greater than 75 horsepower requires a diesel particulate filter (DPF), which substantially increases the initial cost of the machine and which increases maintenance costs.

A larger ICE may be oversized for normal operation of the off-highway machine, which may suggest using a smaller ICE; however, certain conditions may occur in which the combined traction power requirements for moving the machine and hydraulic power for manipulating material may exceed the total power output capacity of the smaller ICE. Such conditions are referred to as “corner conditions” and may occur, for example, when a front loader is moving up a slope with a full load of material in the bucket or when a dozer is pushing a large quantity of material with a blade. The simultaneous application of substantial traction power and substantial hydraulic power when the corner conditions are present may cause the ICE to stall.

### SUMMARY

In view of the foregoing, a need exists for providing a combination of sufficient traction power and sufficient hydraulic power under corner conditions without requiring an oversized ICE having excess power for normal conditions.

One aspect of the embodiments disclosed herein is a system and a method that control the energy required from an internal combustion engine (ICE) of an off-highway machine having terrain-engagement members to move the machine and having hydraulic pumps to provide hydraulic flow to a material manipulation implement. The ICE drives the terrain-engagement members and a first hydraulic pump. The ICE drives an electrical generator to provide electrical energy, which is stored in a battery. The stored electrical energy is selectively provided to an electric motor that drives a second hydraulic pump. When a total energy provided by the ICE exceeds a predetermined level, the hydraulic flow provided by the first hydraulic pump is decreased, and the hydraulic flow provided by the second hydraulic pump is increased. The system and method enable a less powerful ICE to drive the machine.

Another aspect of the embodiments disclosed herein is a method for selectively providing hydraulic power to at least one implement of an off-highway machine. The method comprises driving terrain-engagement members with a first amount of mechanical energy produced by an internal combustion engine to move the off-highway machine. The method selectively drives a first hydraulic pump with a second amount of mechanical energy to provide a first amount of hydraulic flow. The method selectively drives a second hydraulic pump with an electric motor that receives energy from an energy storage device to provide a second amount of hydraulic flow. The method maintains a total of the first amount of mechanical energy and the second amount of mechanical energy less than a threshold amount of mechanical energy by selectively reducing the first amount of hydraulic flow by a differential amount of hydraulic flow to produce a reduced first amount of hydraulic flow. The method adjusts the second amount of hydraulic flow from the second hydraulic pump to compensate for the differential amount of hydraulic flow. The method applies the reduced first amount of hydraulic flow and the second amount of hydraulic flow to the hydraulically powered implement.

In certain embodiments in accordance with this aspect, driving the terrain-engagement members comprises driving a hydrostatic transmission pump with the first amount of mechanical energy from the internal combustion engine to generate hydrostatic energy. The hydrostatic energy is applied to at least one hydrostatic transmission motor to generate mechanical energy to drive the terrain-engagement members.

In certain embodiments in accordance with this aspect, the method drives an alternator with mechanical energy from the internal combustion engine to generate electrical energy; stores the electrical energy from the alternator in the storage device; retrieves electrical energy from the storage device; and applies the electrical energy to the electric motor. In certain embodiments the alternator is an AC generator that generates AC energy; and the method further comprises converting the AC energy to DC energy for storage in the storage device.

In certain embodiments in accordance with this aspect, the method further comprises selectively operating a hydraulic source selection valve to selectively provide hydraulic fluid to the hydraulically powered implement from the first hydraulic pump only, from the second hydraulic pump only, or from both the first hydraulic pump and the second hydraulic pump. In certain embodiments, when the hydraulic source selection valve provides hydraulic fluid from both the first hydraulic pump and the second hydraulic pump, the respective portion of the fluid provided by each pump is selectively variable.

Another aspect of the embodiments disclosed herein is a method for selectively providing hydraulic power to a hydraulic load of an off-highway machine. The method comprises driving terrain-engagement members with energy from an internal combustion engine to move the off-highway machine. The method selectively drives a first hydraulic pump to provide a first source of hydraulic flow. The method drives an electrical generator with the internal combustion engine to generate electrical energy; stores the electrical energy in an energy storage device; and selectively provides the stored electrical energy to drive an electric motor. The electric motor is coupled to a second hydraulic pump to selectively provide a second source of hydraulic flow. When a first energy usage condition occurs, the method provides only the first source of hydraulic flow to at least one hydraulically powered implement attached to the off-highway machine. When a second energy usage condition occurs, the method provides only the second source of hydraulic energy flow to the hydraulically powered implement. When a third energy usage condition occurs, the method provides both the first source of hydraulic flow and the second source of hydraulic flow to the hydraulically powered implement.

In certain embodiments in accordance with this aspect, the internal combustion engine provides a first variable amount of mechanical energy to a hydrostatic transmission pump to drive hydrostatic motors to move the off-highway machine over varying terrain conditions. The internal combustion engine provides a second variable amount of mechanical energy to the first hydraulic pump to drive the hydraulically powered implement attached to the off-highway machine under varying loading conditions. The first energy usage condition occurs when a total of the first variable amount of mechanical energy and the second variable amount of mechanical energy is no greater than a threshold amount of mechanical energy such that only the first hydraulic pump is activated to provide all the hydraulic flow to the hydraulically powered implement. The second energy usage condition occurs when the first variable amount of mechanical energy is near the threshold amount of mechanical energy such that only the second hydraulic pump is activated to provide all the hydraulic flow to the hydraulically powered implement. The third condition occurs when the first variable amount of mechanical energy is less than the threshold amount of mechanical energy and the total of the first variable amount of mechanical energy and the second variable amount of mechanical energy is at least as great as the threshold amount of mechanical energy. When the third condition occurs, the hydraulic flow produced by the first hydraulic pump is reduced by a differential amount such that the total of the first variable amount of mechanical energy and a reduced second variable amount of mechanical energy is less than the threshold amount of mechanical energy; and the second hydraulic pump is activated to produce hydraulic flow corresponding to the differential amount of reduced hydraulic flow produced by the first hydraulic pump.

In certain embodiments in accordance with this aspect, the internal combustion engine is capable of producing a maximum amount of mechanical energy; and the threshold amount of mechanical energy is selected to be less than the maximum amount of mechanical energy.

Another aspect of the embodiments disclosed herein is a hybrid power generation system for an off-highway machine having terrain-engagement members to move the off-highway machine over varying terrain and having at least one hydraulically powered implement attached to the machine for moving materials. The system comprises an internal combustion engine that generates a first variable amount of mechanical energy to drive the terrain-engagement members over varying terrain conditions. A first hydraulic pump is coupled to the internal combustion engine to selectively generate a first variable amount of hydraulic flow to manipulate the hydraulically powered implement attached to the machine. The first hydraulic pump requires a second variable amount of the mechanical energy from the internal combustion engine in response to varying loads on the hydraulically powered implement. An electrical generator is coupled to receive mechanical energy from the internal combustion engine and to generate electrical energy. An energy storage device is coupled to the electrical generator to store the electrical energy generated by the electrical generator. An electric motor receives electrical energy from the energy storage device and selectively operates to provide mechanical energy. A second hydraulic pump receives mechanical energy from the electric motor and selectively generates a second variable amount of hydraulic flow to manipulate the hydraulically powered implement attached to the machine. The second variable amount of hydraulic flow generated by the second hydraulic pump reduces the first variable amount of hydraulic flow generated by the first hydraulic pump and thereby reduces the second variable amount of mechanical energy that drives the first hydraulic pump.

In certain embodiments in accordance with this aspect, the hybrid power generation system further comprises a control system. The control system is configured to determine a total of the first variable amount of mechanical energy and the second variable amount of mechanical energy from the internal combustion engine The control system is further configured to determine whether the total of the first variable amount of mechanical energy and the second variable amount of mechanical energy is less than a threshold amount of mechanical energy. When the total at least the threshold amount of mechanical energy, the control system selectively reduces the first amount of hydraulic flow provided by the first hydraulic pump by a differential amount of hydraulic flow. The control system is further configured to respond to the reduction of the first amount of hydraulic flow provided by the first hydraulic pump by activating the electric motor to cause the second hydraulic pump to generate a second variable amount of hydraulic flow to compensate for the differential amount of the hydraulic flow. In certain embodiments, the control system is configured to enable only the first hydraulic pump when the total of the first variable amount of mechanical energy and the second variable amount of mechanical energy is less than the threshold amount of energy. In certain embodiments, the control system is configured to respond to the first variable amount of mechanical energy being as great as the threshold amount of mechanical energy by discontinuing providing the second variable amount of mechanical energy to the first hydraulic pump; and by enabling the second hydraulic pump to provide the second variable amount of hydraulic flow.

In certain embodiments in accordance with this aspect, the electrical generator is an alternator, which generates rectified DC energy to store in the energy storage device.

In certain embodiments in accordance with this aspect, the electric motor is an AC electric motor, and the hybrid power generation system further comprises a DC-AC inverter coupled between the energy storage device and the electrical motor to provide AC electrical energy to the motor.

In certain embodiments in accordance with this aspect, a hydrostatic pump is coupled to the internal combustion engine to receive mechanical energy and generate hydrostatic energy. Hydrostatic motors are coupled to the hydrostatic pump. The hydrostatic motors are responsive to the hydrostatic energy to selectively generate kinetic energy applied to the terrain-engagement members to move the off-highway machine. The hydrostatic pump uses the first variable amount of the mechanical energy from the internal combustion engine to drive the hydrostatic motors in response to varying terrain conditions.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 illustrates an exemplary off-highway machine into which the improvements disclosed herein may be incorporated, the illustrated off-highway machine including a boom that supports a work implement.

FIG. 2 illustrates the off-highway machine of FIG. 2 with the boom raised and with a portion of a front tire shown in phantom lines to reveal a boom hydraulic cylinder.

FIG. 3 illustrates a schematic block diagram of a conventional electromechanical system of the off-highway machine of FIGS. 1 and 2.

FIG. 4 illustrates a schematic block diagram of an improved electromechanical system of the off-highway machine of FIGS. 1 and 2.

FIG. 5 illustrates a schematic block diagram of an alternative embodiment of the improved electromechanical system of FIG. 4.

FIG. 6 illustrates a flow chart of the operation of the control system of FIGS. 4 and 5.

### DETAILED DESCRIPTION

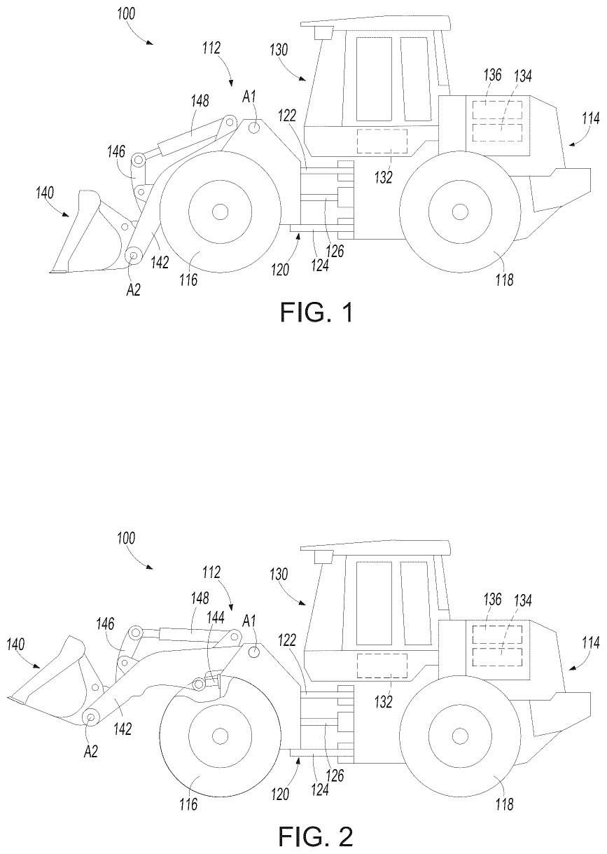

FIG. 1 illustrates a left side view of an exemplary off-highway machine 100 into which the improvements disclosed herein may be incorporated. The right side view of the machine is generally, the mirror image left side view and is not illustrated separately. The illustrated off-highway machine is embodied as a front-end loader (hereinafter “loader”); however, the improvements may also be incorporated into other types of off-highway machines such as dozers, graders, excavators, earthmovers, agricultural machines, and the like. In general, such off-highway machines have large wheels or tracks operating as terrain-engagement members to enable the machines to move on uneven surfaces. The off-highway machines provide a movable platform for material handling implements such as dozer blades, grader blades, loader buckets, excavator buckets that engage material such as dirt, gravel, rocks, trees, and the like, and move the material from a first location to a second location.

The loader 100 of FIG. 1 includes a front body section 112 with a front frame and a rear body section 114 with a rear frame. The front body section includes a set of front wheels 116 with a respective one of the front wheels on each side of the front body section. The rear body section includes a set of rear wheels 118 with a respective one of the rear wheels on each side of the rear body section. The wheels may be referred to herein as terrain-engagement members. Different embodiments can include different terrain-engagement members, such as treads or tracks.

The front body section 112 and the rear body section 114 of the loader 100 are connected to each other by an articulation connection 120 so the front and rear body sections can pivot in relation to each other about a vertical axis. The vertical axis is orthogonal to the direction of travel and orthogonal to rotational axes of the wheel axis. The articulation connection includes at least one upper connection arm 122, at least one lower connection arm 124, and at least a pair of articulation cylinders 126 (only one shown in FIGS. 1 and 2). A respective one of the articulation cylinders is positioned on each side of the loader 100. Pivoting movement of the front body section with respect to the rear body section is achieved by selectively varying hydraulic fluid flow applied to the articulation cylinders to selectively extend and retract the piston rods in the articulation cylinders in a well-known manner.

The rear body section 114 of the loader 100 includes an operator cab 130 in which the operator controls the loader. A user interface 132 is positioned in the cab. The user interface can include different combinations of a steering wheel, control levers, joysticks, control pedals, and control buttons. The operator can actuate one or more controls of the user interface to control movement of the loader front-end loader and the different loader components. The rear body section 114 of the loader also houses a prime mover 134 and a control system 136. The prime mover can comprise an internal combustion engine (ICE), such as a diesel engine. The control system can comprise a vehicle control unit (VCU).

A work implement 140 is moveably connected to the front body section 112 of the loader 100 by at least one boom arm 142. The work implement is used to handle and/or move objects or material such as soil, rocks, debris, or the like. In the illustrated embodiment, the work implement is depicted as a bucket, although other implements, such as a fork assembly, can also be used. Only a single boom arm is shown in the side view of FIG. 1; however, in the illustrated embodiment, a second boom arm (not shown) is positioned in a like location on the opposite side of the front body section. The illustrated boom arm is pivotably connected to the frame of the front body section about a first pivot axis A1 and the illustrated work implement is pivotably connected to the boom arm about a second pivot axis A2. The second boom arm is pivotably connected to the frame of the front body section and to the work implement about corresponding pivot axes on the opposite side of the front body section. Unless otherwise stated, references to the boom arm in the following description apply to both boom arms.

As shown in FIG. 2, at least one boom hydraulic cylinder 144 is mounted to the frame of the front body section 112 and is connected to the boom arm 142. Although only one hydraulic cylinder is shown in the side view of FIG. 2, the illustrated embodiment includes at least a second hydraulic cylinder (not shown) with the second cylinder positioned on the opposite side and connected to the second boom arm (not shown). In other embodiments, the loader 100 may have additional boom hydraulic cylinders. The boom hydraulic cylinders can be extended or retracted to raise or lower the boom arm and thus adjust the vertical position of the work implement 140 relative to the front body section 112.

As shown in FIGS. 1 and 2, at least one pivot linkage 146 is connected to the work implement 140 and to the boom arm 142. At least one pivot hydraulic cylinder 148 is mounted to the boom arm and is connected to the pivot linkage. In the illustrated embodiment, a second pivot hydraulic cylinder (not shown) is connected to the second boom arm (not shown) and a second pivot linkage (not shown) on the opposite side of the loader 100. The loader may have additional pivot hydraulic cylinders to provide additional force for pivoting the work implement. The pivot hydraulic cylinders can be extended or retracted to pivot the work implement about the second pivot axis A2. In some embodiments, the work implement may be moved in different manners (e.g., around additional pivot axes) and a different number or configuration of hydraulic cylinders or other actuators may be used.

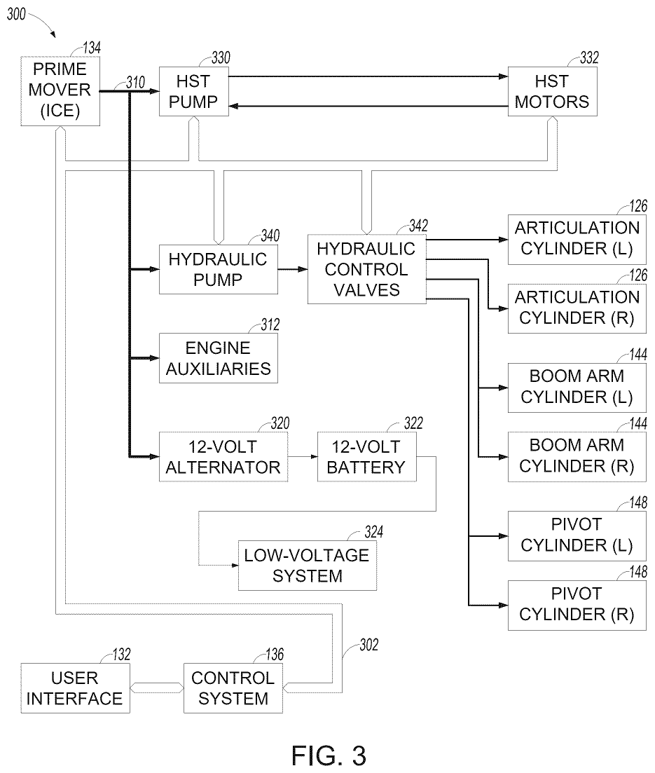

FIG. 3 illustrates a schematic block diagram of a conventional electromechanical system 300 of a conventional implementation of the loader 100 of FIGS. 1 and 2. The electromechanical system includes the control system 136 and the user interface 132. The control system monitors and controls other components of the loader. The control system can include outputs and inputs connected to and from the components described below. In the illustrated embodiment, the control system is connected to the components via a communications bus 302. For example, the communications bus may be a conventional controller area network (CAN) bus.

The conventional electromechanical system 300 includes the prime mover 134 (e.g., the ICE) of FIGS. 1 and 2, which provides mechanical energy (e.g., rotational energy) on an output shaft 310. The prime mover is responsive to commands received from the control system 136 via the bus 302 and provides performance information to the control system via the bus.

The mechanical (rotational) energy from the prime mover 134 is provided to engine auxiliaries (e.g., water pumps, oil pumps, and the like) 312 directly from the output shaft as illustrated or via one or more belts, gearboxes, or the like. The engine auxiliaries operate in conventional manners and are not described in detail herein.

The prime mover 134 also provides mechanical power to drive an alternator 320. The alternator can be coupled directly to the output shaft 310 as illustrated or via one or more belts, gearboxes, or the like. The alternator generates an internal AC voltage and includes internal components (e.g., a rectifier (not shown)) to produce a DC output voltage. The DC output voltage is applied to a conventional 12-volt battery 322. The 12-volt battery provides electrical energy to a low-voltage electrical system 324, which represents electrically powered components of the loader. Such components include, for example, the control system 136, the user interface 132, lighting (not shown), a starter motor (not shown), and other conventional electrically powered components. The alternator and the electrically powered components operate in conventional manners in response to commands from the user interface via the control system. The structures and the operations of the alternator and the electrically powered components are not described in detail herein.

The prime mover 134 also provides mechanical energy to a hydrostatic transmission pump (HST pump) 330. The HST pump can be coupled directly to the output shaft 310 as illustrated or via one or more belts, gearboxes, or the like. The HST pump generates hydraulic fluid flow. The hydraulic fluid is selectively coupled to and from a plurality of hydrostatic transmission motors (HST motors) 332. The HST motors are controlled by the control system 136 via the bus 302 in response to operator commands from the user interface 132 to provide kinetic energy to the terrain-engaging members (e.g., the front wheels 116 and the rear wheels 118 in the illustrated embodiment) to selectively move the loader 100 over terrain in a conventional manner. In alternative embodiments, the prime mover can provide mechanical energy directly to the terrain-engagement members via a gearbox (not shown) and other mechanical interconnections (not shown).

The prime mover 134 also provides mechanical energy to a hydraulic pump 340. The hydraulic pump can be coupled directly to the output shaft 310 as illustrated or via one or more belts, gearboxes, or the like. The hydraulic pump is controlled by commands received from the control system 136 via the bus 302. The hydraulic pump also provides information (e.g., pressure, fluid flow, and the like) to the control system via the bus.

The hydraulic pump 340 produces hydraulic fluid flow. The hydraulic fluid is coupled to a set of hydraulic control valves 342. The hydraulic control valves are controlled by commands from the user interface 132 via the control system 136. The commands are communicated to the hydraulic control valves via the bus 302. The hydraulic control valves selectively apply hydraulic fluid flow to the articulation cylinders 126 to control the orientation of the front body section 112 with respect to the rear body section 114. The hydraulic control valves selectively apply hydraulic fluid flow to the boom hydraulic cylinders 144 to raise and lower the boom arms 142. The hydraulic control valves selectively apply hydraulic fluid flow to the pivot hydraulic cylinders 148 to pivot the work implement 140. The cylinders are shown in pairs with the parenthetical “L” and “R” indicating the left and right cylinders of each pair.

As illustrated in FIG. 3, the hydraulic pump 340 receives energy from the prime mover (ICE) 134. Thus, when the loader 100 is moving and manipulating material simultaneously, the prime mover must be able to provide sufficient power to the HST pump 330 to provide traction power to drive the HST motors 332 and to simultaneously provide power to the hydraulic pump 340 so that the hydraulic pump provides hydraulic power to drive the articulation cylinders 126, the boom hydraulic cylinders 144, and the pivot hydraulic cylinders 148. As discussed above, corner conditions can occur when the traction power is high (e.g., the loader is moving up a grade with a full load) and the hydraulic power is also high (e.g., the boom arm 142 is rising, the work implement 140 is tilting upward, and the front body section 112 is articulating with respect to the rear body section 114). Under such corner conditions, the total power required from the prime mover can be greater than the available power from the prime mover. As further discussed above, one solution is to increase the size of the prime mover to accommodate the maximum power required under full traction load and full hydraulic load. However, increasing the size of the prime mover incurs additional costs, additional engine volume, likely lower efficiency, and increased pollution control requirements. In most applications, the loader will spend relatively little time under corner conditions such that increasing the size of the prime mover to accommodate the corner conditions provides relatively little benefit to counterbalance the disadvantages.

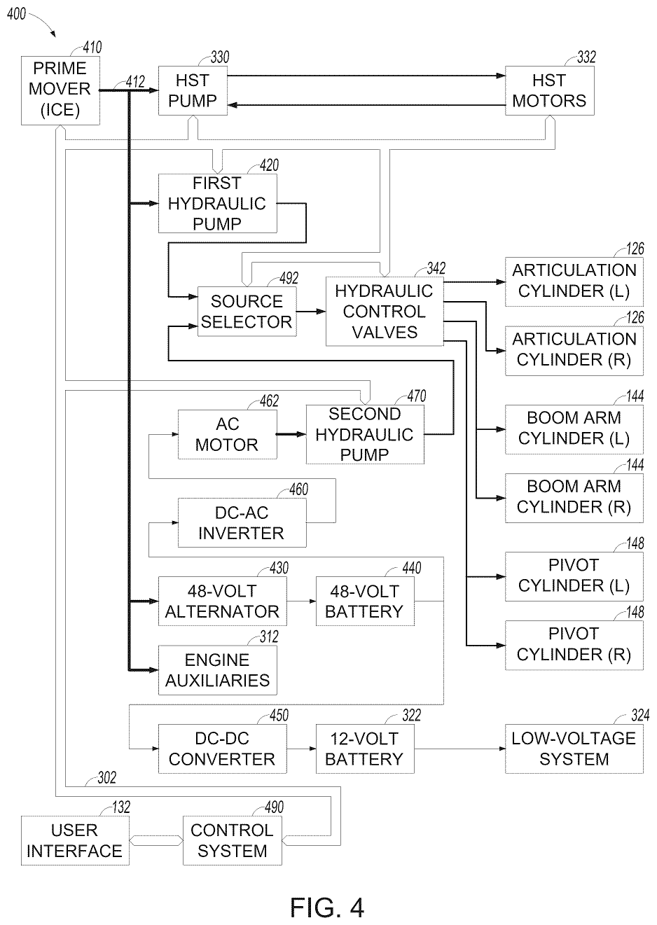

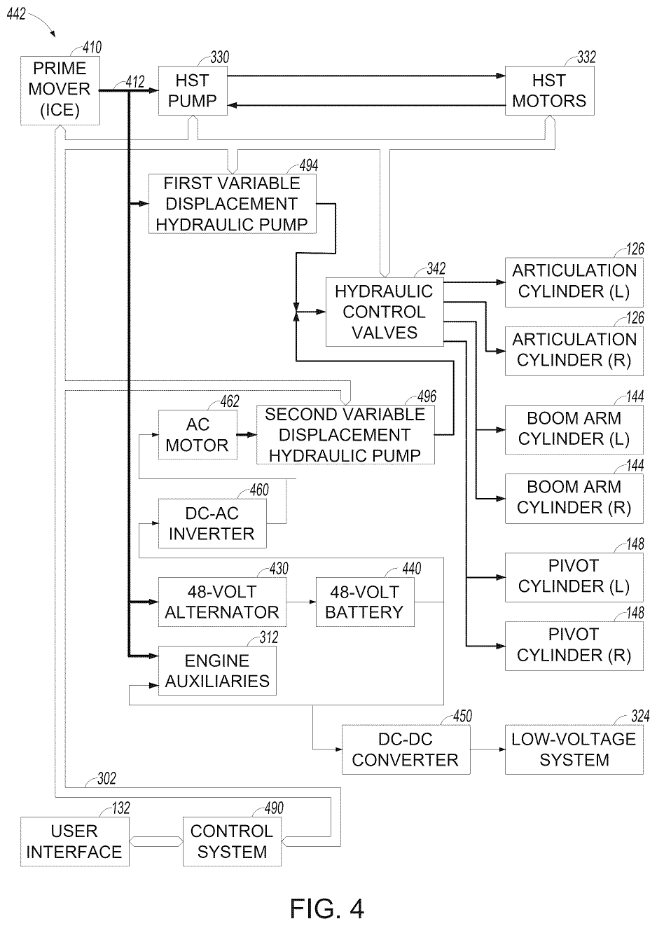

FIG. 4 illustrates a block diagram of an improved electromechanical system 400 of an improved implementation of the loader 100 of FIGS. 1 and 2. The improved electromechanical system of FIG. 4 includes many of the components described above for the conventional electromechanical system 300 of FIG. 3. Like components in FIG. 4 are numbered as in FIG. 3, and like components operate as described above.

Unlike the conventional electromechanical system 300 of FIG. 3, the improved electromechanical system 400 of FIG. 4 replaces the larger prime mover 134 of FIG. 3 with a smaller (e.g., lower-powered) prime mover 410. For example, the prime mover implemented as a diesel ICE can produce no more than 75 horsepower to avoid the stricter requirements for larger engines. The improvements described herein also can be used to improve the efficiency of off-highway vehicles having larger prime movers. The prime mover rotates a shaft 412 that drives the HST pump 330 to provide hydrostatic power to the HST motors 332 as in FIG. 3. The prime mover also drives a first hydraulic pump 420, which corresponds to the hydraulic pump 340 of FIG. 3.

The improved electromechanical system 400 replaces the conventional 12-volt alternator 320 of FIG. 3 with a 48-volt alternator 430. The 48-volt alternator generates a 48-volt DC output, which is provided to a 48-volt energy storage device (e.g., a storage battery) 440, which may be implemented as a single battery or as multiple batteries connected in series or connected in series/parallel based on the battery configuration. The output of the 48-volt storage battery is provided to a DC-DC converter 450, which operates in a conventional manner to produce an output voltage of 12 volts. In the illustrated embodiment, the output voltage from the DC-DC converter is provided to the conventional 12-volt battery 322, which provides electrical energy to the low-voltage electrical system 324 as described above. In an alternative embodiment, the 12-volt battery can be eliminated by operating the DC-DC converter continuously to convert the output of the 48-volt storage battery to 12 volts. The presence of the continuous 12-volt energy supply allows the low-voltage electrical system to be connected directly to the DC-DC converter as shown for an alternative improved electromechanical system 442 in FIG. 5.

In the alternative improved electromechanical system 442 illustrated in FIG. 5, the electrical energy output from the 48-volt storage battery 440 can also be provided to at least some of the engine auxiliaries 312. For example, the energy from the 48-volt storage battery can be applied to one or more of an electrically powered fan (E-fan), an electrically powered compressor, a positive temperature coefficient (PTC) heater, or the like, which can replace corresponding conventional components. Other engine auxiliaries (e.g., the water pump) can continue to receive mechanical energy from the prime mover 410 via the shaft 412.

The DC output voltage of the 48-volt storage battery 440 is also provided as an input to a DC-AC inverter 460, which converts the DC voltage to an AC voltage suitable to drive an AC electric motor 462. The electric motor provides mechanical energy to a second hydraulic pump 470.

The first hydraulic pump 420 and the second hydraulic pump 470 are hydraulically coupled to the set of hydraulic control valves 342 to selectively provide hydraulic fluid flow to the control valves. The hydraulic control valves are controlled by an improved control system 490, which operates as described above for the control system 136 to selectively provide hydraulic fluid flow to the articulation cylinders 126, to the boom hydraulic cylinders 144, and to the pivot hydraulic cylinders 148 as described above. The hydraulic control valves 342 of FIG. 4 receive hydraulic fluid from at least one source selection valve 492, which is also controlled by the improved control system. The source selection valve can be controlled to direct hydraulic fluid to the hydraulic control valves from the first hydraulic pump, from the second hydraulic pump, or from both hydraulic pumps. When hydraulic fluid is provided from both hydraulic pumps, the percentage of the fluid provided by each pump is adjustable.

In the alternative embodiment such as the system 442 in FIG. 5, the source selection valve 492 at the input of the hydraulic control valves 342 can be omitted by replacing the first hydraulic pump 420 and the second hydraulic pump 470 by a first variable displacement hydraulic pump 494 and a second variable displacement hydraulic pump 496, respectively. The outputs of the two pumps are combined at the input of the hydraulic control valves. Each variable displacement pump can be independently controlled by the improved control system 490 to provide respective variable fluid flows to the hydraulic control valves.

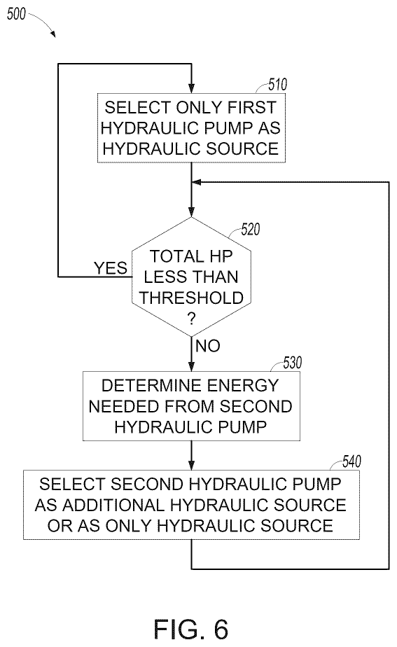

The improved electromechanical system 400 of FIG. 4 operates in accordance with a flowchart 500 of FIG. 6. During normal (non-corner-condition) operations, the total amount of energy needed to drive the non. hydraulic loads (e.g., the HST motors 332, the 48-volt alternator 430, and the engine auxiliaries 312) and the amount of energy needed to drive the hydraulic loads via the first hydraulic pump 420 is no more than the maximum energy output (e.g., no more than 75 horsepower) of the prime mover (ICE) 410. During such normal conditions, the improved control system 490 operates in a first activity block 510 wherein the improved control system controls the source selection valve 492 such that all the hydraulic fluid provided to the hydraulic valves 342 is provided by the first hydraulic pump.

The improved control system 490 continually monitors the mechanical energy required from the prime mover 410. In a decision block 520, the improved control system determines whether the total mechanical energy required to drive the HST pump 330, the first hydraulic pump 420, the engine auxiliaries 312, and the 48-volt alternator 430 is less than the total mechanical energy production capability of the prime mover 410. Although the system can monitor all the mechanical energy requirements, in the illustrated embodiment the mechanical energy requirements of the engine auxiliaries and the alternator are substantially less than the mechanical energy requirements of the HST pump and the hydraulic pump. Thus, a threshold mechanical energy level can be set to a level that is lower than the maximum energy capability of the prime mover to accommodate the mechanical energy required to operate the engine auxiliaries and the alternator. The threshold mechanical energy level can be further lowered to provide a margin below the maximum mechanical energy such that the adjustments described below can occur before the total mechanical energy reaches the maximum mechanical energy output of the prime mover. For example, the threshold mechanical energy level may be set at 70 horsepower for a prime mover having a maximum energy capability of 75 horsepower. The threshold mechanical energy level can be modified if the mechanical energy required to operate the engine auxiliaries and the alternator changes. If the total mechanical energy requirement of the HST pump and the first hydraulic pump is less than the threshold mechanical energy level, the improved control system returns to the first activity block 510 and continues to provide hydraulic fluid to the hydraulic valves 342 only from the first hydraulic pump 420 via the source selection valve 492.

If the improved control system 490 determines in the decision block 520 that the total energy required to drive the HST pump 330 and the first hydraulic pump is at or above the threshold mechanical energy level as described above, the improved control system advances to a second activity block 530. In the second activity block, the improved control system determines the extent to which the required total mechanical energy exceeds the threshold mechanical energy level and determines the amount of hydraulic energy needed from the second hydraulic pump 470 to replace or supplement the energy from the first hydraulic pump.

In a third activity block 540, the improved control system 490 turns on the AC electric motor 462 to drive the second hydraulic pump 470. The improved control system also controls the source selection valve 492 to direct hydraulic fluid form the second hydraulic pump to the hydraulic control valves 342. Depending on the amount of supplemental hydraulic energy needed to keep the total energy required from the prime mover 410 below the threshold mechanical energy level, the source selection valve may be actuated to provide hydraulic fluid to the hydraulic control valves from only the second hydraulic pump or from both the first hydraulic pump 420 and the second hydraulic pump. For example, if the corner condition results from the energy required by the HST pump 330 being at or near the threshold mechanical energy level, the source selection valve can be actuated to provide all the hydraulic fluid from the second hydraulic pump. As used herein, “near the threshold” is used to indicate that the control system may not wait until the energy required by the HST pump reaches the threshold level before activating the second hydraulic pump. The control system can anticipate that the energy required by the HST pump is increasing and can begin activating the second hydraulic pump below the threshold level. For slowly increasing HST pump energy demands, the second hydraulic pump can be activated a few (e.g., 1-4) horsepower below the threshold lever. For rapidly increasing HST pump energy demands, the second hydraulic pump can be activated at lower levels below the threshold level.

On the other hand, if the energy required by the HST pump 330 is below the threshold mechanical level and the corner condition is the result of large hydraulic loads in addition to the energy required by the HST pump, the improved control system 490 can actuate the source selection valve to continue to provide a portion of the hydraulic fluid from the first hydraulic pump and to provide a portion the hydraulic fluid from the second hydraulic pump. By continuing to provide a portion of the hydraulic fluid from the first hydraulic pump, the improved control system reduces the drain on the 48-volt storage battery during this type of corner condition.

After activating the second hydraulic pump 470 and adjusting the source selection valve 492 in the third activity block 540, the improved control system 490 returns to the decision block 520 wherein the improved control system again determines whether the total energy requirement of the improved electromechanical system 400 indicates the continuation of the corner condition as described above. If the system is still in a corner condition such the energy required by the HST pump 330 and the energy required by the first hydraulic pump 420 are at or above the threshold mechanical level, the improved control system advances to the second activity block, wherein the improved control system maintains the state of the second hydraulic pump and the state of the source selection valve if the corner condition has not changed. The improved control system can also adjust the states of the second hydraulic pump and the source selection valve if the loading on the prime mover from the HST motors has changed or if the loading on the articulation cylinders 126, the boom arm hydraulic cylinders 144, and the pivot hydraulic cylinders 148 have changed.

If the improved control system 490 determines in the decision block 520 that the improved electromechanical system 400 is no longer operating in a corner condition, the improved control system returns from the decision block to the first activity block 510 wherein the improved control system adjusts the source selection valve 492 to direct hydraulic fluid from the first hydraulic pump 420 only to the hydraulic control valves 342. The improved control system can also turn off the AC electric motor 462 that drives the second hydraulic pump 470.

As another example, the prime mover 410 may be operating well below the maximum capability when the work implement 140 encounters a large load, which quickly increases the fluid flow required to operate the boom arm hydraulic cylinders 144 and the pivot hydraulic cylinders 148. The control system is able to detect this condition in the decision block 520 and turn on the AC electric motor 462 to drive the second hydraulic pump 470 is able to quickly respond to the increased energy requirements so that the prime mover does not have to increase the mechanical output quickly to respond to the increased load.

One skilled in the art will appreciate that energy is required from the prime mover 410 to generate the electrical energy to charge the 48-volt storage battery 440 and thereby provide energy to the AC electric motor 462 that drives the second hydraulic pump 470. Although the total energy required may increase because of energy conversion inefficiencies, the electrical energy stored in the storage battery is generated during intervals during which the prime mover is not operating in a corner condition. The energy is released from the storage battery during a corner condition so that the prime mover can operate without stalling. The hybrid structure thus allows a smaller prime mover to provide sufficient power without being oversized for normal operating conditions.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

1. A method for selectively providing hydraulic power to at least one hydraulically powered implement of an off highway machine wherein the hydraulically powered implement operates under variable load conditions requiring variable magnitudes of hydraulic power, the method comprising:
driving terrain-engagement members with a first amount of mechanical energy produced by an internal combustion engine to move the off-highway machine:
selectively driving a first hydraulic pump with a second amount of mechanical energy to provide a first amount of hydraulic flow;
selectively driving a second hydraulic pump with an electric motor that receives energy from an energy storage device to provide a second amount of hydraulic flow; and
maintaining a total of the first amount of mechanical energy and the second amount of mechanical energy less than a threshold amount of mechanical energy by selectively reducing the first amount of hydraulic flow by a differential amount of hydraulic flow to produce a reduced first amount of hydraulic flow;
adjusting the second amount of hydraulic flow from the second hydraulic pump to compensate for the differential amount of hydraulic flow; and
applying the reduced first amount of hydraulic flow and the second amount of hydraulic flow to the hydraulically powered implement.

2. The method as defined in claim 1 wherein driving the terrain-engagement members comprises driving a hydrostatic transmission pump with the first amount of mechanical energy from the internal combustion engine to generate hydrostatic energy, the hydrostatic energy applied to at least one hydrostatic transmission motor to generate mechanical energy to drive the terrain-engagement members.

3. The method as defined in claim 1 further comprising:
driving an alternator with mechanical energy from the internal combustion engine to generate electrical energy;
storing the electrical energy from the alternator in the energy storage device; and
retrieving electrical energy from the energy storage device; and
applying the electrical energy to the electric motor.

4. The method as defined in claim 3 wherein the alternator is an AC generator that generates the electrical energy as AC energy, and the method further comprises converting the AC energy to DC energy for storage in the energy storage device.

5. A method for selectively providing hydraulic power to at least one hydraulically powered implement of an off highway machine, the method comprising:
driving terrain-engagement members with a first amount of mechanical energy produced by an internal combustion engine to move the off-highway machine:
selectively driving a first hydraulic pump with a second amount of mechanical energy to provide a first amount of hydraulic flow;
selectively driving a second hydraulic pump with an electric motor that receives energy from an energy storage device to provide a second amount of hydraulic flow;
maintaining a total of the first amount of mechanical energy and the second amount of mechanical energy less than a threshold amount of mechanical energy by selectively reducing the first amount of hydraulic flow by a differential amount of hydraulic flow to produce a reduced first amount of hydraulic flow;
adjusting the second amount of hydraulic flow from the second hydraulic pump to compensate for the differential amount of hydraulic flow; and
applying the reduced first amount of hydraulic flow and the second amount of hydraulic flow to the hydraulically powered implement and
selectively operating a hydraulic source selection valve to selectively provide hydraulic fluid to the hydraulically powered implement from the first hydraulic pump only, from the second hydraulic pump only, or from both the first hydraulic pump and the second hydraulic pump.

6. The method as defined in claim 5 wherein, when the hydraulic source selection valve provides the hydraulic fluid from both the first hydraulic pump and the second hydraulic pump, the respective portion of the fluid provided by each pump is selectively variable.

7. (canceled)

8. A method for selectively providing hydraulic power to a hydraulic load of an off-highway machine, the method comprising:
driving terrain-engagement members with a first variable amount of mechanical energy from an internal combustion engine to move the off-highway machine;
selectively driving a first hydraulic pump with a second variable amount of mechanical energy from the internal combustion engine to provide a first source of hydraulic flow;
driving an electrical generator with the internal combustion engine to generate electrical energy;
storing the electrical energy in an energy storage device;
selectively providing the stored electrical energy to drive an electric motor, the electric motor coupled to a second hydraulic pump to selectively provide a second source of hydraulic flow;
when a first energy usage condition occurs, providing only the first source of hydraulic flow to at least one hydraulically powered implement attached to the off-highway machine;
when a second energy usage condition occurs, providing only the second source of hydraulic flow to the hydraulically powered implement; and
when a third energy usage condition occurs, providing both the first source of hydraulic flow and the second source of hydraulic flow to the hydraulically powered implement;
wherein:
the internal combustion engine provides the energy as a first variable amount of mechanical energy for driving a hydrostatic transmission pump to drive hydrostatic transmission motors that drive terrain-engagement members to move the off-highway machine over varying terrain conditions;
the internal combustion engine provides a second variable amount of mechanical energy to the first hydraulic pump to drive the hydraulically powered implement attached to the off-highway machine under varying loading conditions of the hydraulically powered implement and the terrain-engagement members; and
the first energy usage condition occurs when a total of the first variable amount of mechanical energy and the second variable amount of mechanical energy is no greater than a threshold amount of mechanical energy such that only the first hydraulic pump is activated to provide all the hydraulic flow to the hydraulically powered implement;
the second energy usage condition occurs when the first variable amount of mechanical energy is at the threshold amount of mechanical energy such that only the second hydraulic pump is activated to provide all the hydraulic flow to the hydraulically powered implement; and
the third energy usage condition occurs when the first variable amount of mechanical energy is less than the threshold amount of mechanical energy and the total of the first variable amount of mechanical energy and the second variable amount of mechanical energy is at least as great as the threshold amount of mechanical energy, wherein:
the hydraulic flow produced by the first hydraulic pump is reduced by a differential amount such that the total of the first variable amount of mechanical energy and a reduced second variable amount of mechanical energy is no greater than the threshold amount of mechanical energy; and
the second hydraulic pump is activated to produce hydraulic flow corresponding to the differential amount of reduced hydraulic flow produced by the first hydraulic pump.

9. The method as defined in claim 8 wherein:
the internal combustion engine is capable of producing a maximum amount of mechanical energy; and
the threshold amount of mechanical energy is selected to be less than the maximum amount of mechanical energy.

10. A hybrid power generation system for an off-highway machine having terrain-engagement members to move the off-highway machine over varying terrain and having at least one hydraulically powered implement attached to the machine for moving materials, the system comprising:
an internal combustion engine that generates a first variable amount of mechanical energy to drive the terrain-engagement members over varying terrain conditions;
a first hydraulic pump coupled to the internal combustion engine to selectively generate a first variable amount of hydraulic flow to manipulate the hydraulically powered implement attached to the machine, the first hydraulic pump requiring a second variable amount of the mechanical energy from the internal combustion engine in response to varying loads on the hydraulically powered implement;
an electrical generator coupled to receive mechanical energy from the internal combustion engine and to generate electrical energy;
an energy storage device coupled to the electrical generator to store the electrical energy generated by the electrical generator;
an electric motor that receives the electrical energy from the energy storage device and that selectively operates to provide electrically generated mechanical energy;
a second hydraulic pump that receives the electrically generated mechanical energy from the electric motor and that selectively generates a second variable amount of hydraulic flow to manipulate the hydraulically powered implement attached to the machine, machine; and
a control system configured to selectively increase the second variable amount of hydraulic flow generated by the second hydraulic pump to reduce the first variable amount of hydraulic flow generated by the first hydraulic pump to thereby reduce the second variable amount of mechanical energy that drives the first hydraulic pump.

11. The hybrid power generation system as defined in claim 10 further comprising a control system configured to:
determine a total of the first variable amount of mechanical energy and the second variable amount of mechanical energy from the internal combustion engine; and
determine whether the total of the first variable amount of mechanical energy and the second variable amount of mechanical energy is at least as great as a threshold amount of mechanical energy, and when the total exceeds the threshold amount of mechanical energy, selectively reducing the first amount of hydraulic flow provided by the first hydraulic pump by a differential amount of hydraulic flow; and
respond to the reduction of the first amount of hydraulic flow provided by the first hydraulic pump by activating the electric motor to cause the second hydraulic pump to generate the second variable amount of hydraulic flow to compensate for the differential amount of the hydraulic flow.

12. The hybrid power generation system as defined in claim 11 wherein the control system is configured to:
enable only the first hydraulic pump when the total of the first variable amount of mechanical energy and the second variable amount of mechanical energy is less than the threshold amount of energy.

13. The hybrid power generation system as defined in claim 11 wherein the control system is configured to respond to the first variable amount of mechanical energy being as great as the threshold amount of mechanical energy by:
discontinuing providing the second variable amount of mechanical energy to the first hydraulic pump; and
enabling the second hydraulic pump to provide the second variable amount of hydraulic flow.

14. The hybrid power generation system as defined in claim 10 wherein the electrical generator is an alternator, which generates the electrical energy as rectified DC energy to store in the energy storage device.

15. The hybrid power generation system as defined in claim 10 wherein the electric motor is an AC electric motor, and the hybrid power generation system further comprises a DC-AC inverter coupled between the energy storage device and the electrical motor to provide the electrical energy AC electrical energy to the motor.

16. The hybrid power generation system as defined in claim 10 further comprising:
a hydrostatic transmission pump coupled to the internal combustion engine to receive the mechanical energy and to generate hydrostatic energy; and
hydrostatic transmission motors coupled to the hydrostatic pump, the hydrostatic transmission motors responsive to the hydrostatic energy to selectively generate kinetic energy with the terrain-engagement members to move the off-highway machine, the hydrostatic transmission pump using the first variable amount of the mechanical energy from the internal combustion engine to drive the hydrostatic transmission motors in response to the varying terrain conditions.

17. The method as defined in claim 5 wherein driving the terrain-engagement members comprises driving a hydrostatic transmission pump with the first amount of mechanical energy from the internal combustion engine to generate hydrostatic energy, the hydrostatic energy applied to at least one hydrostatic transmission motor to generate mechanical energy to drive the terrain-engagement members.

18. The method as defined in claim 5 further comprising:
driving an alternator with mechanical energy from the internal combustion engine to generate electrical energy;
storing the electrical energy from the alternator in the energy storage device; and
retrieving electrical energy from the energy storage device; and
applying the electrical energy to the electric motor.

19. The method as defined in claim 18 wherein the alternator is an AC generator that generates the electrical energy as AC energy, and the method further comprises converting the AC energy to DC energy for storage in the energy storage device.
